(19) United States
(12) Patent Application Publication
(10) Pub. No.: US 2024/0142319 A1
(43) Pub. Date: May 2, 2024

(54) LOAD SENSOR

(71) Applicant: Panasonic Intellectual Property Management Co., Ltd., Osaka (JP)

(72) Inventors: Yodai MATSUMURA, Osaka (JP); Takashi MATSUMOTO, Osaka (JP); Susumu URAGAMI, Kumamoto (JP); Yuta MORIURA, Osaka (JP); Takafumi HAMANO, Fukuoka (JP); Hiroyuki FURUYA, Osaka (JP)

(21) Appl. No.: 18/405,828

(22) Filed: Jan. 5, 2024

Related U.S. Application Data
(63) Continuation of application No. PCT/JP2022/014152, filed on Mar. 24, 2022.

(30) Foreign Application Priority Data
Jul. 9, 2021 (JP) 2021-114004

(51) Int. Cl. G01L 1/14

(52) U.S. Cl. CPC G01L 1/142

(57) ABSTRACT

A load sensor includes: an electrically-conductive elastic body; an electrically-conductive member having a linear shape and disposed so as to cross the electrically-conductive elastic body; and a dielectric body disposed between the electrically-conductive elastic body and the electrically-conductive member. A width of the electrically-conductive elastic body in a longitudinal direction of the electrically-conductive member is changed such that a relationship between a load and a contact area between the electrically-conductive elastic body and the electrically-conductive member via the dielectric body becomes close to a linear relationship.

### CROSS REFERENCE TO RELATED APPLICATION

This application is a continuation of International Application No. PCT/JP2022/014152 filed on Mar. 24, 2022, entitled “LOAD SENSOR”, which claims priority under 35 U.S.C. Section 119 of Japanese Patent Application No. 2021-114004 filed on Jul. 9, 2021, entitled “LOAD SENSOR”. The disclosures of the above applications are incorporated herein by reference.

### BACKGROUND OF THE INVENTION

### Field of the Invention

The present invention relates to a load sensor which detects a load applied from outside, based on change in capacitance.

### DESCRIPTION OF RELATED ART

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2018/096901 describes a pressure-sensitive element. (load sensor) including: a first electrically-conductive member formed from an electrically-conductive rubber having a sheet shape; a second electrically-conductive member having a linear shape and sandwiched by the first electrically-conductive member and a base member; and a dielectric body formed so as to cover the second electrically-conductive member. In this configuration, in association with increase in the load, the contact area between the first electrically-conductive member and the dielectric body increases, and in association with this, the capacitance between the first electrically-conductive member and the second electrically-conductive member increases. When the value of the capacitance between the first electrically-conductive member and the second electrically-conductive member is detected, the load applied to the pressure-sensitive element can be detected.

In the above configuration, since the second electrically-conductive member has a columnar shape, the contact area between the first electrically-conductive member and the dielectric body does not linearly change in association with increase in the load. Therefore, it is difficult to detect smoothly and in a simple manner the load applied to the pressure-sensitive element, from the value of the capacitance between the first electrically-conductive member and the second electrically-conductive member.

### SUMMARY OF THE INVENTION

A load sensor according to a main aspect of the present invention includes: an electrically-conductive elastic body; an electrically-conductive member having a linear shape and disposed so as to cross the electrically-conductive elastic body; and a dielectric body disposed between the electrically-conductive elastic body and the electrically-conductive member. A width of the electrically-conductive elastic body in a longitudinal direction of the electrically-conductive member is changed such that a relationship between a load and a contact area between the electrically-conductive elastic body and the electrically-conductive member via the dielectric body becomes close to a linear relationship.

With the load sensor according to the present aspect, due to change in the width of the electrically-conductive elastic body, the relationship between the load and the contact area between the electrically-conductive elastic body and the electrically-conductive member is made close to a linear relationship. Thus, the relationship between the load and the capacitance is also made close to a linear relationship. Therefore, through detection of the capacitance between the electrically-conductive elastic body and the electrically-conductive member, the applied load can be detected smoothly and in a simple manner.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is a perspective view schematically showing a sheet-shaped member on the lower side and electrically-conductive elastic bodies set on an opposing face of the sheet-shaped member on the lower side, according to an embodiment;

FIG. 1B is a perspective view schematically showing a state where conductor wires and threads are set on the structure in FIG. 1A, according to the embodiment;

FIG. 2A is a perspective view schematically showing a sheet-shaped member on the upper side and electrically-conductive elastic bodies set on an opposing face of the sheet-shaped member on the upper side, according to the embodiment;

FIG. 2B is a perspective view schematically showing a state where the structure in FIG. 2A is set on the structure in FIG. 1B, according to the embodiment;

FIG. 3A and FIG. 3B each schematically show a cross section of a sensor part, according to the embodiment;

FIG. 4 is a plan view schematically showing a configuration of the inside of a load sensor, according to the embodiment;

FIG. 5A is a cross-sectional view schematically showing a contact portion between the conductor wire and the electrically-conductive elastic bodies, according to the embodiment;

FIG. 5B is a plan view schematically showing a configuration of the vicinity of a crossing position between the conductor wire and the electrically-conductive elastic bodies, according to Comparative Example;

FIG. 6A is a graph showing the relationship between the load and the length of the arc of the contact portion, according to Comparative Example;

FIG. 6B is a plan view schematically showing a configuration of the vicinity of the crossing position between the conductor wire and the electrically-conductive elastic bodies, according to the embodiment;

FIG. 7 schematically shows a condition for simulation, according to verification of the embodiment;

FIG. 8 is a graph showing the relationship between the contact area and the load when a constant α was changed, according to verification of the embodiment;

FIG. 9A to FIG. 9D each show a shape in a plan view of the electrically-conductive elastic body, according to verification of the embodiment;

FIG. 10 schematically shows a condition for simulation, according to verification of the embodiment;

FIG. 11 is a graph showing the relationship between the load and the contact area when a width β was changed, according to verification of the embodiment;

FIG. 12A to FIG. 12D each show a shape in a plan view of the electrically-conductive elastic body, according to verification of the embodiment;

FIG. 13 is a schematic diagram for describing a change ratio, according to verification of the embodiment;

FIG. 14A is a graph showing the relationship between the load and the contact area when the change ratio was changed in association with change in the constant α, according to verification of the embodiment;

FIG. 14B is a graph showing an approximate straight line of each curve in FIG. 14A, according to verification of the embodiment;

FIG. 15 is a schematic diagram for describing effects of a cutout having a symmetrical shape, according to the embodiment;

FIG. 16A and FIG. 16B are each a plan view schematically showing a configuration of the vicinity of the crossing position between the conductor wire and the electrically-conductive elastic body, according to a modification;

FIG. 17A and FIG. 17B are each a plan view schematically showing a configuration of the vicinity of the crossing position between the conductor wire and the electrically-conductive elastic body, according to a modification;

FIG. 18A and FIG. 18B are each a plan view schematically showing a configuration of the vicinity of the crossing position between the conductor wire and the electrically-conductive elastic body, according to a modification; and

FIG. 19A and FIG. 198 each schematically show a cross section of a sensor part, according to a modification.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiment below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiment below is connected to a detection circuit, and the load sensor and the detection circuit form a load detection device. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

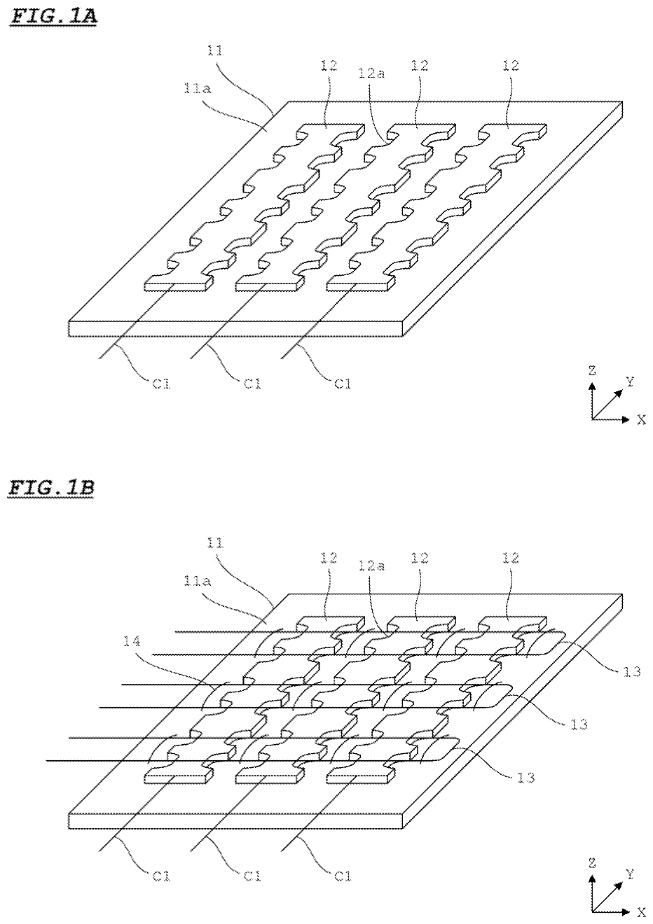

FIG. 1A is a perspective view schematically showing a sheet-shaped member 11 and electrically-conductive elastic bodies 12 set on an opposing face 11a (the face on the Z-axis positive side) of the sheet-shaped member 11.

The sheet-shaped member 11 is an insulative member having elasticity, and has a flat plate shape parallel to an X-Y plane. The thickness in the Z-axis direction of the sheet-shaped member 11 is 0.01 mm to 2 mm, for example.

The sheet-shaped member 11 is formed from a non-electrically-conductive resin material or a non-electrically-conductive rubber material. The resin material used in the sheet-shaped member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the sheet-shaped member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face 11a (the face on the Z-axis positive side) of the sheet-shaped member 11. In FIG. 1A, three electrically-conductive elastic bodies 12 are formed on the opposing face 11a of the sheet-shaped member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable C1 electrically connected to the electrically-conductive elastic body 12 is set.

In each electrically-conductive elastic body 12, a plurality of cutouts 12a are formed inwardly from an end portion on the X-axis positive side and from an end portion on the X-axis negative side. Each cutout 12a is provided at a position through which a later-described conductor wire 13 (see FIG. 1B) passes.

Each electrically-conductive elastic body 12 is formed on the opposing face 11a of the sheet-shaped member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the sheet-shaped member 11.

Each electrically-conductive elastic body 12 is formed from a resin material and an electrically-conductive filler dispersed therein, or from a rubber material and an electrically-conductive filler dispersed therein.

Similar to the resin material used in the sheet-shaped member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the sheet-shaped member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃, (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where the conductor wires 13 and threads 14 are disposed on the structure in FIG. 1A.

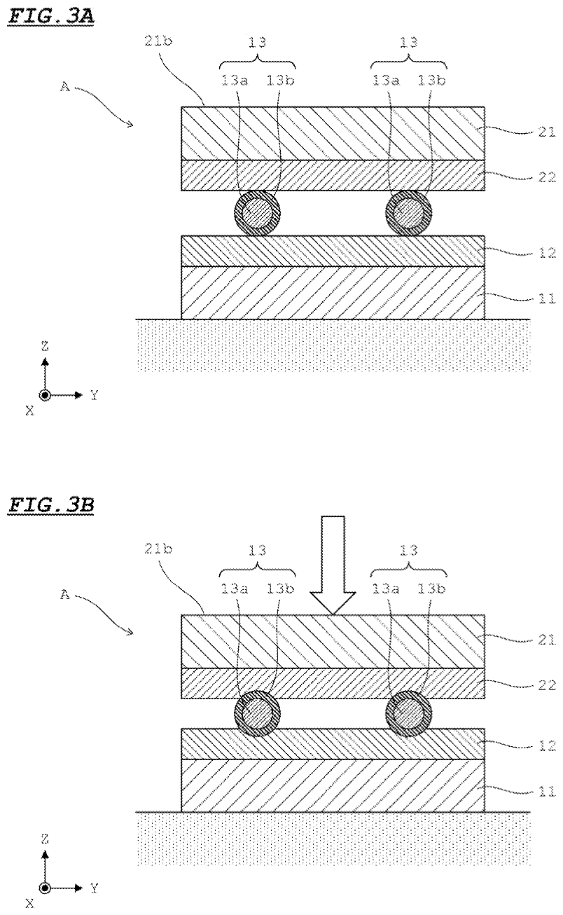

Each conductor wire 13 has a linear shape and extends in the X-axis direction. The conductor wire 13 is bent in the vicinity of an end portion on the X-axis positive side of the sheet-shaped member 11. The bent conductor wire 13 (hereinafter, referred to as a “pair of the conductor wires 13”) is composed of a conductor wire 13 extending in the X-axis direction on the Y-axis positive side and a conductor wire 13 extending in the X-axis direction on the Y-axis negative side. These two conductor wires 13 are disposed with a predetermined interval therebetween. Pairs of the conductor wires 13 are disposed in the Y-axis direction with a predetermined interval therebetween. In the example shown in FIG. 1B, three pairs of the conductor wires 13 are disposed. Each conductor wire 13 is composed of: an electrically-conductive member having a linear shape; and a dielectric body formed on the surface of the electrically-conductive member. The configuration of the conductor wire 13 will be described later with reference to FIGS. 3A, 3B.

After a plurality of pairs of the conductor wires 13 have been disposed as in FIG. 1B, each pair of the conductor wires 13 is set on the sheet-shaped member 11 by threads 14. In the example shown in FIG. 1B, twelve threads 14 connect the pairs of the conductor wires 13 to the sheet-shaped member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

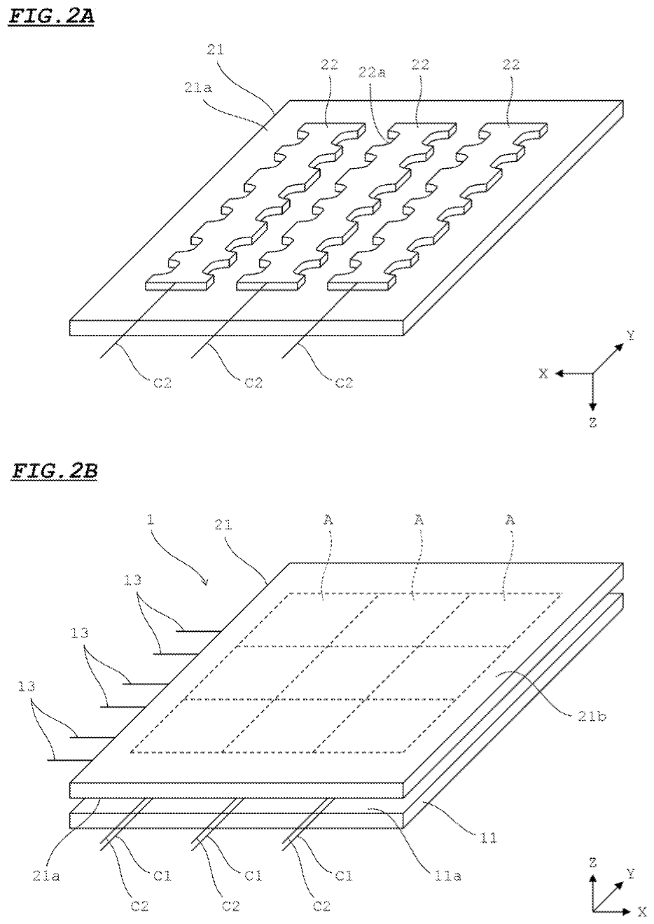

FIG. 2A is a perspective view schematically showing a sheet-shaped member 21 and electrically-conductive elastic bodies 22 set on an opposing face 21a (the face on the Z-axis negative side) of the sheet-shaped member 21.

The sheet-shaped member 21 has, in a plan view, the same size and shape as those of the sheet-shaped member 11 and is formed from the same material as that of the sheet-shaped member 11. The thickness in the Z-axis direction of the sheet-shaped member 21 is 0.01 mm to 2 mm, for example.

The electrically-conductive elastic bodies 22 extend in the Y-axis direction, and are formed so as to be arranged with a predetermined interval therebetween in the X-axis direction. The electrically-conductive elastic bodies 22 are formed on the opposing face 21a of the sheet-shaped member 21, at positions opposing the electrically-conductive elastic bodies 12 on the sheet-shaped member 11. Each electrically-conductive elastic body 22 has, in a plan view, the same size and shape as those of the electrically-conductive elastic body 12, and is formed from the same material as that of electrically-conductive elastic body 12. Similar to the electrically-conductive elastic body 12, the electrically-conductive elastic body 22 is formed on the opposing face 21a of the sheet-shaped member 21 by a predetermined printing method. At an end portion on the Y-axis negative side of each electrically-conductive elastic body 22, a cable C2 electrically connected to the electrically-conductive elastic body 22 is set.

In each electrically-conductive elastic body 22 as well, a plurality of cutouts 22a are formed inwardly from an end portion on the X-axis positive side and from an end portion on the X-axis negative side. In a plan view, each cutout 12a in the electrically-conductive elastic body 12 and each cutout 22a in the electrically-conductive elastic body 22 have the same shape with each other. When the load sensor 1 has been assembled, the cutout 12a and the cutout 22a overlap each other at the same position in a plan view.

FIG. 2B is a perspective view schematically showing a state where the structure in FIG. 2A is set on the structure in FIG. 1B.

The structure shown in FIG. 2A is disposed from above (the Z-axis positive side) the structure shown in FIG. 1B. At this time, the sheet-shaped member 11 and the sheet-shaped member 21 are disposed such that: the opposing face 11a and the opposing face 21a face each other; and the electrically-conductive elastic bodies 12 and the electrically-conductive elastic bodies 22 are superposed with each other. Then, outer peripheral four sides of the sheet-shaped member 21 are connected to the outer peripheral four sides of the sheet-shaped member 11 with a silicone-rubber-based adhesive, a thread, or the like, whereby the sheet-shaped member 11 and the sheet-shaped member 21 are fixed to each other. Accordingly, the conductor wires 13 are sandwiched by the electrically-conductive elastic bodies 12 and the electrically-conductive elastic bodies 22. Accordingly, the load sensor 1 is completed as shown in FIG. 2B.

Here, in the load sensor 1, in a plan view, a plurality of sensor parts A arranged in a matrix shape are formed. In the load sensor 1 above, a total of nine sensor parts A arranged in the X-axis direction and the Y-axis direction are formed. One sensor part A is positioned at an intersection of the electrically-conductive elastic bodies 12, 22 arranged in the Z-axis direction and a pair of the conductor wires 13. One sensor part A includes the electrically-conductive elastic bodies 12, 22, a pair of the conductor wires 13, and the sheet-shaped members 11, 21 in the vicinity of the intersection. When the load sensor 1 is set on a predetermined installation surface, and a load is applied to an upper face 21b (the face on the Z-axis positive side) of the sheet-shaped member 21 forming the sensor part A, the capacitance between the electrically-conductive elastic bodies 12, 22 and the electrically-conductive members in the pair of the conductor wires 13 change, and the load is detected based on the capacitance.

FIGS. 3A, 3B each schematically show a cross section of a sensor part A, along a plane parallel to a Y-Z plane at the center position in the X-axis direction of the sensor part A. FIG. 3A shows a state where no load is applied, and FIG. 3B shows a state where a load is applied.

As shown in FIGS. 3A, 3B, each conductor wire 13 is composed of an electrically-conductive member 13a and a dielectric body 13b formed on the electrically-conductive member 13a. The electrically-conductive member 13a is a wire member having a linear shape, and the dielectric body 13b covers the surface of the electrically-conductive member 13a. In FIGS. 3A, 3B, the face on the Z-axis negative side of the sheet-shaped member 11 is set on the installation surface.

As shown in FIG. 3A, when no load is applied, the force applied between the electrically-conductive elastic body 12 and the conductor wire 13, and the force applied between the electrically-conductive elastic body 22 and the conductor wire 13 is substantially zero. From this state, as shown in FIG. 3B, when a load is applied in the downward direction to the upper face 21b of the sheet-shaped member 21 corresponding to the sensor part A, the electrically-conductive elastic bodies 12, 22, and the sheet-shaped members 11, 21 are deformed by the conductor wire 13.

As shown in FIG. 3B, when a load is applied, the conductor wire 13 is brought close to the electrically-conductive elastic bodies 12, 22 so as to be wrapped by the electrically-conductive elastic bodies 12, 22, and the contact area between the conductor wire 13 and the electrically-conductive elastic bodies 12, 22 increases. Accordingly, the capacitance between the electrically-conductive member 13a and electrically-conductive elastic body 12 and the capacitance between the electrically-conductive member 13a and electrically-conductive elastic body 22 change. Then, the capacitance regarding the pair of the conductor wires 13 included in the sensor part A is detected, whereby the load applied to the sensor part A is calculated.

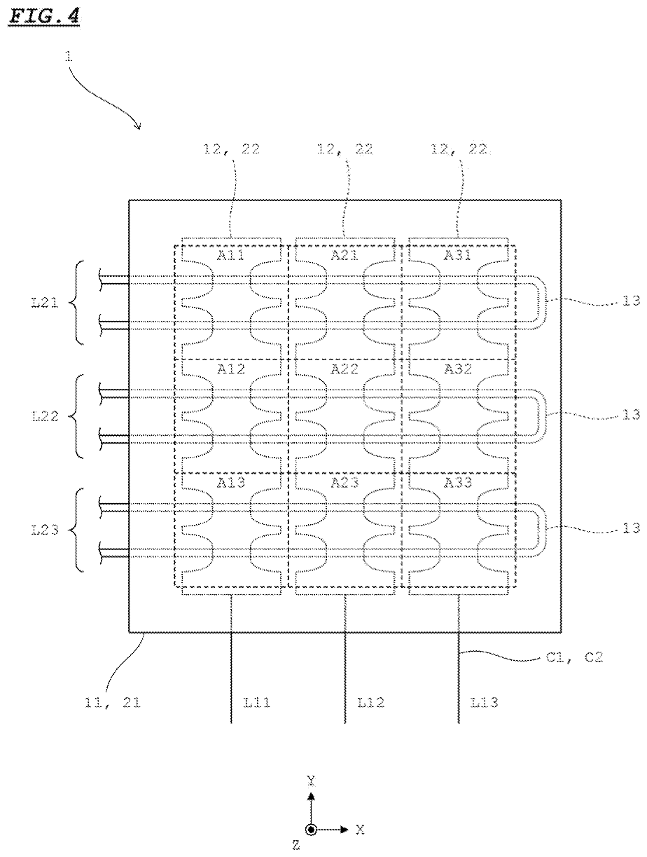

FIG. 4 is a plan view schematically showing a configuration of the inside of the load sensor 1. In FIG. 4, the threads 14 are not shown for convenience.

In a measurement region of the load sensor 1, nine sensor parts A arranged in the X-axis direction and the Y-axis direction are set. The nine sensor parts A correspond to nine positions at each of which the electrically-conductive elastic bodies 12, 22 and adjacent two conductor wires 13 (a pair of the conductor wires 13) cross each other. In FIG. 4, at the nine positions, nine sensor parts A11, A12, A13, A21, A22, A23, A31, A32, A33 in each of which the capacitance changes in accordance with a load are formed.

In each sensor part, the pair of the conductor wires 13 forms one pole (e.g., positive pole) for capacitance, and the electrically-conductive elastic bodies 12, 22 form the other pole (e.g., negative pole) for capacitance. That is, the electrically-conductive members 13a (see FIGS. 3A, 3B) in the pair of the conductor wires 13 form one electrode of the load sensor 1 (capacitance-type load sensor), the electrically-conductive elastic bodies 12, 22 form the other electrode of the load sensor 1 (capacitance-type load sensor), and the dielectric bodies 13b (see FIGS. 3A, 3B) in the pair of the conductor wires 13 correspond to a dielectric body that defines the capacitance in the load sensor 1 (capacitance-type load sensor).

When a load is applied in the Z-axis direction to each sensor part, the pair of the conductor wires 13 are wrapped by the electrically-conductive elastic bodies 12, 22. Accordingly, the contact area between the pair of the conductor wires 13 and the electrically-conductive elastic bodies 12, 22 changes, and the capacitance between the electrically-conductive members 13a of the pair of the conductor wires 13 and the electrically-conductive elastic bodies 12, 22 changes.

End portions on the X-axis negative side of each pair of the conductor wires 13 and end portions on the Y-axis negative side of the cables C1, C2 are connected to a detection circuit set for the load sensor 1. The electrically-conductive members 13a in the pair of the conductor wires 13 are connected to each other in the detection circuit, and the cables C1, C2 are connected to each other in the detection circuit.

As shown in FIG. 4, the cables C1, C2 drawn from the three sets of the electrically-conductive elastic bodies 12, 22 will be referred to as lines L11, L12, L13, and the electrically-conductive members 13a in the three pairs of the conductor wires 13 will be referred to as lines L21, L22, L23. The positions at which the electrically-conductive elastic bodies 12, 22 connected to the line L11 cross the lines L21, L22, L23 are the sensor parts A11, A12, A13, respectively. The positions at which the electrically-conductive elastic bodies 12, 22 connected to the line L12 cross the lines L21, L22, 1.23 are the sensor parts A21, A22, A23, respectively. The positions at which the electrically-conductive elastic bodies 12, 22 connected to the line L13 cross the lines L21, L22, L23 are the sensor parts A31, A32, A33, respectively.

When a load is applied to the sensor part A11, the contact area between the electrically-conductive members 13a of the pair of the conductor wires 13 and the electrically-conductive elastic bodies 12, 22 increases in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

In the present embodiment, as described above, the width in the X-axis direction of the electrically-conductive elastic bodies 12, 22 is not constant in the entire length thereof in the Y-axis direction, and is changed in accordance with the shape of the cutouts 12a, 22a due to the provision of the cutouts 12a, 22a at the position where each conductor wire 13 crosses the electrically-conductive elastic bodies 12, 22. In the present embodiment, since the width of the electrically-conductive elastic bodies 12, 22 is changed in this manner, the relationship between the load and the contact area between the electrically-conductive elastic bodies 12, 22 and the conductor wire 13 is made close to a linear relationship as described below.

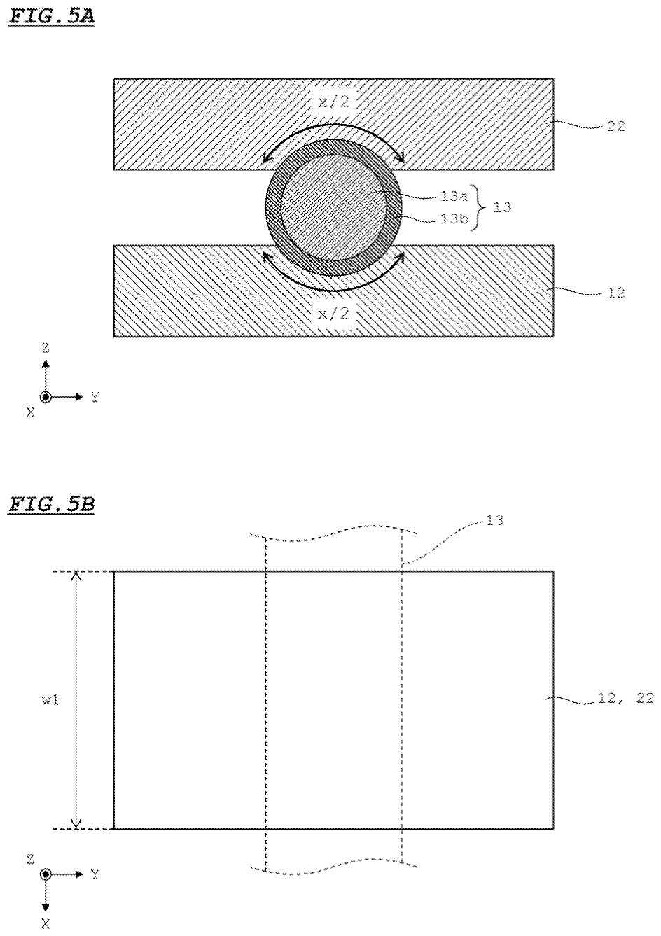

FIG. 5A is a cross-sectional view schematically showing a contact portion between the conductor wire 13 and the electrically-conductive elastic bodies 12, 22, along a plane parallel to a Y-Z plane at the center position in the X-axis direction of the electrically-conductive elastic bodies 12, 22.

As shown in FIG. 5A, when a load is applied, the conductor wire 13 sinks in and is wrapped by the electrically-conductive elastic bodies 12, 22. At this time, the entire length of the arc of the contact portion between the conductor wire 13 and the electrically-conductive elastic bodies 12, 22 when viewed in the X-axis direction is defined as x. In this case, the length of the arc of the contact portion on the upper side and the length of the arc of the contact portion on the lower side are each x/2.

FIG. 5B is a plan view schematically showing a configuration of the vicinity of a crossing position between the conductor wire 13 and the electrically-conductive elastic bodies 12, 22 of a case (Comparative Example) where the cutouts 12a, 22a are not provided in the electrically-conductive elastic bodies 12, 22. That is, in Comparative Example, the width in the X-axis direction of the electrically-conductive elastic bodies 12, 22 is constant and is w1. In FIG. 5B, the conductor wire 13 is indicated by a broken line. Similar to the case in FIG. 5A, the lengths of the arcs of the contact portion between the conductor wire 13 and the electrically-conductive elastic bodies 12, 22 are each x/2, and the entire length (total) of these arcs is x.

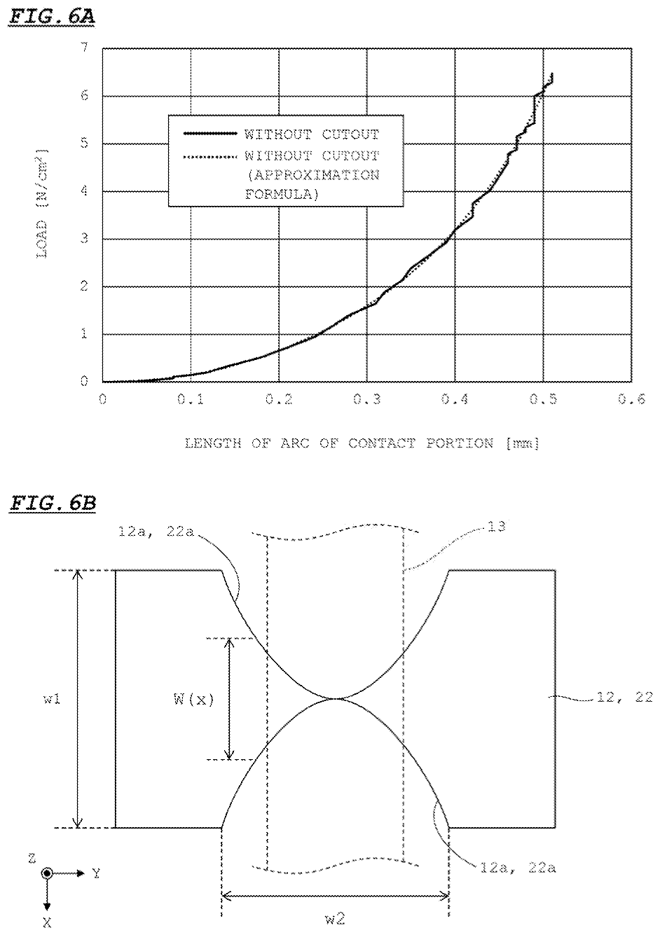

FIG. 6A is a graph (simulation result) showing the relationship between the load and the length (x) of the arc of the contact portion in Comparative Example.

In FIG. 6A, the horizontal axis represents the length x (mm) of the arc of the contact portion, and the vertical axis represents the load f(x) (N/cm²). In FIG. 6A, due to the relationship with the resolving power of the simulation, there are small fluctuations in the graph. The actual relationship between the load and the length x of the arc is defined by the graph indicated by a dotted line in FIG. 6A. As shown in FIG. 6A, the value of the load can be represented by function f(x).

In Comparative Example, since the shape of the electrically-conductive elastic bodies 12, 22 is a rectangle, a contact area S between the conductor wire 13 and the electrically-conductive elastic bodies 12, 22 is obtained by multiplying the length x of the arc by a constant width w1. Therefore, the relationship between the load f(x) and the contact area S is not a linear relationship, either. Thus, when the relationship between the load f(x) and the contact area S is not linear, the relationship between the load f(x) and the capacitance detected by the sensor part A is not, linear, either. Thus, the load applied to the load sensor 1 is difficult to be detected smoothly and in a simple manner.

Thus, the inventors considered that, if, at an arbitrary x, there is a proportional relationship between the increase degree of the load f(x) and the increase degree of the contact area S, a proportional relationship (linearity) is established between the load f(x) and the contact area S, and a proportional relationship (linearity) is also established between the load f(x) and the capacitance detected by the sensor part A.

That is, when the following relationship is established, a proportional relationship (linearity) can be established between the load and the contact area.

dS/dx∝f′(x) (1)

Here, the change in the contact area S on the left side of formula (1) corresponds to the width in the X-axis direction of the electrically-conductive elastic bodies 12, 22. Therefore, when the variable x is expanded in terms of the longitudinal direction of the electrically-conductive elastic bodies 12, 22, and the width of the electrically-conductive elastic bodies 12, 22 is expressed in terms of W(x), if the following relationship formula (2) is established, a proportional relationship (linearity) can be established between the load f(x) and the contact area S.

W(x)=α·f′(x) (2)

That is, as shown in FIG. 6B, when the cutouts 12a, 22a are respectively provided in the electrically-conductive elastic bodies 12, 22, and based on the formula (2) above, the electrically-conductive elastic bodies 12, 22 are set such that the width W(x) changes according to the length x of the arc, a proportional relationship (linearity) can be established between the load f(x) and the contact area S. In this case, a width w2 in the Y-axis direction of the cutouts 12a, 22a is set to be in a range in which the conductor wire 13 contacts the electrically-conductive elastic bodies 12, 22 when the maximum load in the detection range is applied. The width w2 is set to ½ of the outer circumferential length of the cross section of the conductor wire 13, for example.

The constant α for establishing the proportional relationship (linearity) between the load and the contact area can be changed depending on the diameter of the conductor wire 13, the elastic force of the electrically-conductive elastic bodies 12, 22, the width w1 of the electrically-conductive elastic bodies 12, 22, and the like.

Next, the inventors verified, through simulation, the relationship between the magnitude of the constant rx and the linearity between the load f(x) and the contact area S.

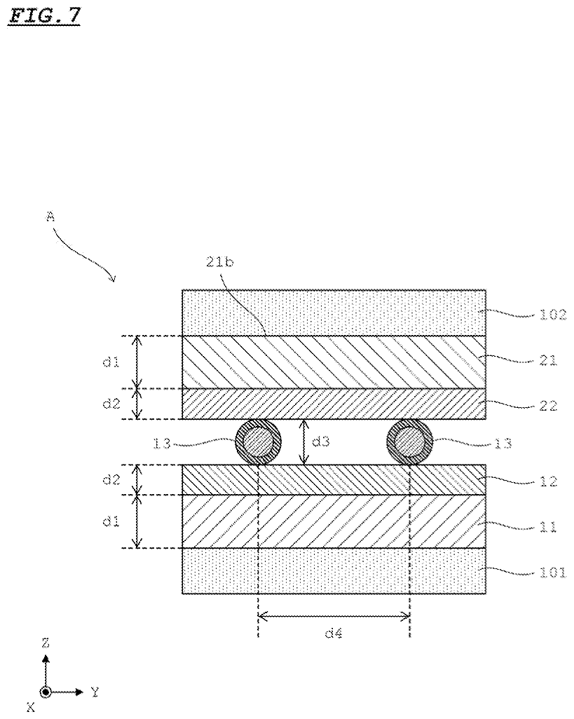

FIG. 7 schematically shows a condition for the simulation.

As shown in FIG. 7, as a configuration for the simulation, the inventors assumed one sensor part A similar to that having the configuration in FIGS. 3A, 3B. The lower face of the sheet-shaped member 11 was set on the upper face of a base 101. A presser 102 was set on the upper face 21b of the sheet-shaped member 21. A thickness d1 of the sheet-shaped members 11, 21 was set to 1 mm. A thickness d2 of the electrically-conductive elastic bodies 12, 22 was set to 0.03 mm. An outer circumferential diameter d3 of the conductor wire 13 was set to 0.3 mm. A distance d4 between the centers of two conductor wires 13 was set to 5 mm. The elastic modulus of the sheet-shaped members 11, 21 was set to 3 MPa. The elastic modulus of the electrically-conductive elastic bodies 12, 22 was set to 3 MPa.

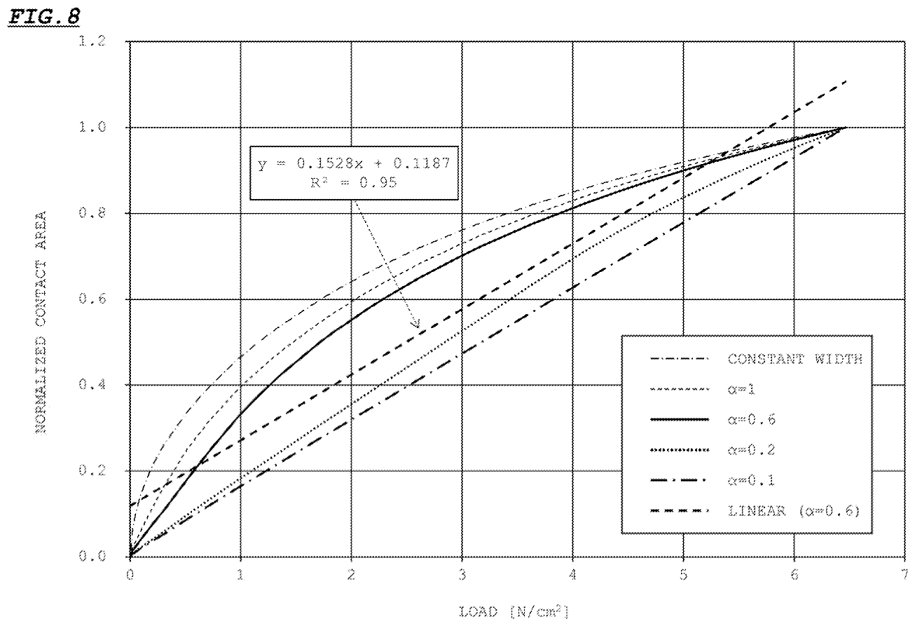

FIG. 8 is a graph showing the relationship between the load and the contact area when the constant α was changed.

In the graph in FIG. 8, the horizontal axis represents the load (N/cm²), and the vertical axis represents the value obtained by normalizing the contact area with the value of the contact area at a value (6.464) of the maximum load. The contact area here is the sum of the areas where one conductor wire 13 is in contact with the respective electrically-conductive elastic bodies 12, 22.

As shown in FIG. 8, when the electrically-conductive elastic bodies 12, 22 have a constant width, that is, when the cutouts 12a, 22a are not provided in the electrically-conductive elastic bodies 12, 22 as in Comparative Example shown in FIG. SB, the relationship between the load and the contact area exhibits a curved shape having the largest curvature. When the constant α becomes smaller, the relationship between the load and the contact area becomes more linear, accordingly. When the graph having 0.6 as the value of the constant α is approximated to a straight line, with the horizontal axis representing x and the vertical axis representing y, the formula of the approximate straight line becomes y=0.1528x+0.1187. At this time, the value of a coefficient of determination R² becomes 0.95.

This verification result reveals that, when the constant α is smaller, the relationship between the load and the contact area becomes close to a linear relationship. Therefore, in order to make the relationship between the load and the contact area close to a linear relationship, it can be said that it is preferable to set the constant α to be as small as possible. However, on the other hand, when the constant α is smaller, the contact area between the conductor wire 13 and the electrically-conductive elastic bodies 12, 22 when the same load is applied becomes small.

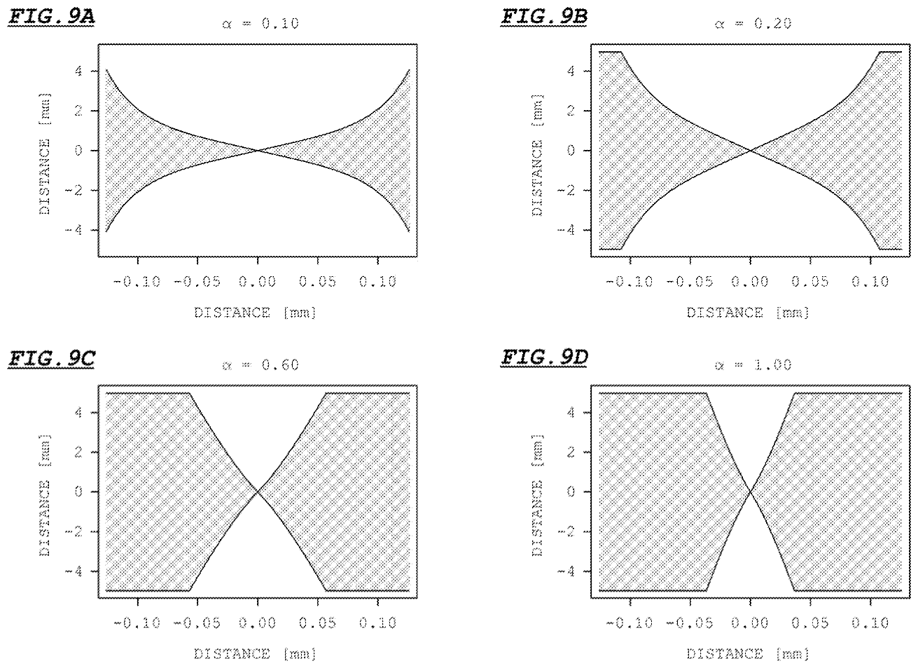

FIGS. 9A to 9D each show a shape of the electrically-conductive elastic bodies 12, 22 in a plan view.

In FIGS. 9A to 9D, the horizontal axis represents the distance (mm) when the center position in the Y-axis direction of the conductor wire 13 is defined as 0, and the vertical axis represents the distance (mm) when the center position in the X-axis direction (width direction) of the electrically-conductive elastic bodies 12, 22 is defined as 0. FIGS. 9A to 9D respectively show the shapes of the electrically-conductive elastic bodies 12, 22 when the constant α is 0.10, 0.20, 0.60, and 1.00.

As shown in FIGS. 9A to 9D, when the constant α becomes smaller, the width in the lateral direction (the Y-axis direction) of the cutouts 12a, 22a increases, and the width in the vertical direction (the X-axis direction) of the electrically-conductive elastic bodies 12, 22 decreases. Therefore, when the constant α becomes smaller, change in the capacitance according to change in the load becomes small, and the sensitivity of the detection of the load decreases. In addition, when the constant α becomes smaller, the width in the X-axis direction of the electrically-conductive elastic bodies 12, 22 decreases, and thus, the resistance value of the electrically-conductive elastic bodies 12, 22 becomes large.

Thus, when the constant α is reduced, there is a trade-off relationship between: improvement of the linearity of the relationship between the load and the contact area; and decrease in the detection sensitivity of the load and increase in the resistance value of the electrically-conductive elastic bodies 12, 22. Therefore, it is preferable that the constant α is set in consideration of such a trade-off relationship.

In the simulation result shown in FIG. 8, when the constant α was 0.6, the coefficient of determination R² was 0.95, and linearity between the load and the contact area was able to be relatively favorably ensured. Therefore, the constant α may be set in a range of larger than 0 and not larger than 0.6 in consideration of the above trade-off relationship.

In the above verification, as shown in FIG. 6B, the width in the X-axis direction of the electrically-conductive elastic bodies 12, 22 at the disposition position of the conductor wire 13 was assumed to be 0. However, when the electrically-conductive elastic bodies 12, 22 are formed by a printing method, the width of the electrically-conductive elastic bodies 12, 22 cannot be set to 0, and needs to be set to at least not less than 1 μm.

Then, the inventors verified, through simulation, the relationship between the load and the contact area when the width of the electrically-conductive elastic bodies 12, 22 at the disposition position of the conductor wire 13 was changed.

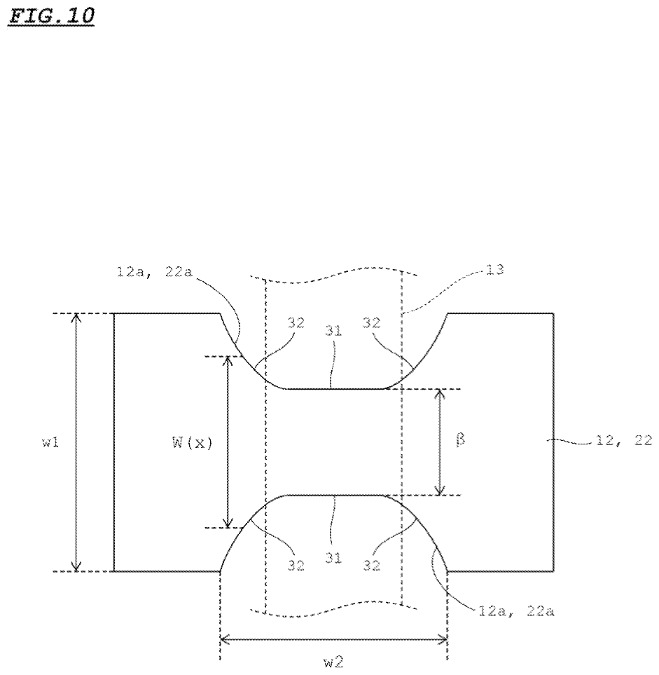

FIG. 10 schematically shows a condition for this simulation.

As shown in FIG. 10, the width in the X-axis direction of the electrically-conductive elastic bodies 12, 22 at the position where the conductor wire 13 and the electrically-conductive elastic bodies 12, 22 cross each other was defined as β. The middle position of the width β was aligned with the middle position of the width w1. Straight line parts 31 parallel to the Y-axis direction were set at the position of the width β. From both ends of the width w2, with an inclination of the constant α, curved line parts 32 were set up to a corresponding straight line part 31. The cutouts 12a, 22a were each formed by one straight line part 31 and the curved line parts 32 on both sides of the straight line part 31. The cutouts 12a, 22a had a shape that was symmetrical in a direction (the Y-axis direction) perpendicular to the longitudinal direction of the conductor wire 13 and symmetrical in the longitudinal, direction (the X-axis direction) of the conductor wire 13. The symmetry axis in the Y-axis direction of the cutouts 12a, 22a was set at the middle position in the Y-axis direction of the conductor wire 13.

In the simulation, the value of the constant α was fixed to 0.6, and the width β was changed. How the relationship between the load and the contact area changed due to the width β was verified.

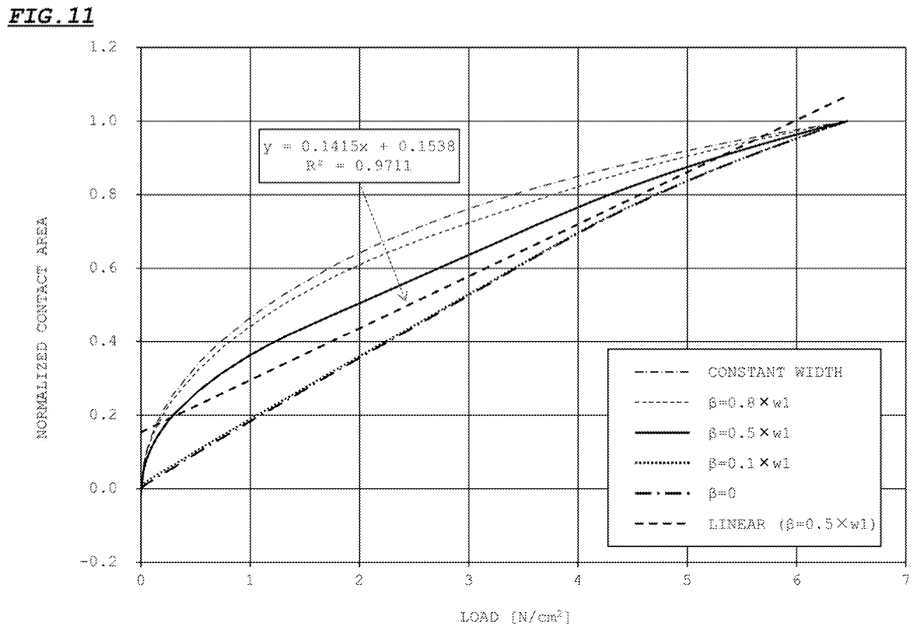

FIG. 11 is a graph showing the relationship between the load and the contact area when the width β was changed.

In the graph in FIG. 11 as well, the horizontal axis represents the load (N/cm²), and the vertical axis represents the value obtained by normalizing the contact area with the value of the contact area at a value (6.464) of the maximum load.

As shown in FIG. 11, when the electrically-conductive elastic bodies 12, 22 have a constant width, that is, when the cutouts 12a, 22a are not provided in the electrically-conductive elastic bodies 12, 22 as in Comparative Example shown in FIG. 5B, the relationship between the load and the contact area exhibits a curved shape having the largest curvature. When the width β (becomes smaller, the relationship between the load and the contact area becomes more linear, accordingly. When the graph having 0.5 as the value of the width β is approximated to a straight line, with the horizontal axis representing x and the vertical axis representing y, the formula of the approximate straight line becomes y=0.1415x+0.1538. At this time, the value of the coefficient of determination R² becomes 0.9711.

This verification result reveals that, when the width β is smaller, the relationship between the load and the contact area becomes close to a linear relationship. Therefore, in order to make the relationship between the load and the contact area close to a linear relationship, it can be said that it is preferable to set the width β to be as small as possible. However, on the other hand, when the width β is smaller, the contact area between the conductor wire 13 and the electrically-conductive elastic bodies 12, 22 when the same load is applied becomes small.

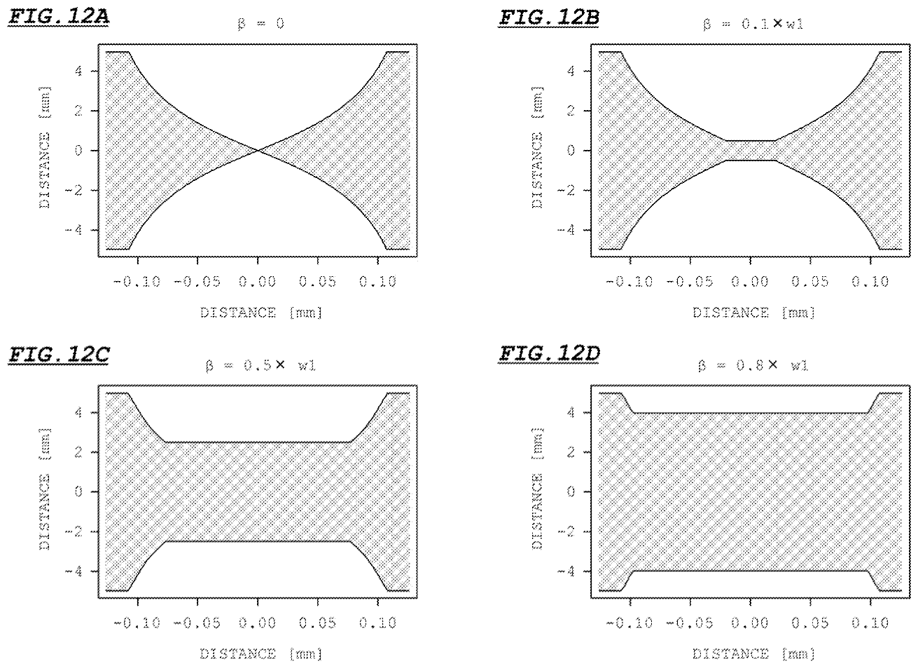

FIGS. 12A to 12D each show a shape of the electrically-conductive elastic bodies 12, 22 in a plan view. FIGS. 12A to 12D respectively show the shapes of the electrically-conductive elastic bodies 12, 22 when the width β is 0, 0.1×w1, 0.5×w1, and 0.8×w1.

As shown in FIGS. 12A to 12D, when the width β becomes smaller, the width in the vertical direction (the X-axis direction) of the electrically-conductive elastic bodies 12, 22 decreases. Therefore, change in the capacitance according to change in the load becomes small, and the sensitivity of the detection of the load decreases. In addition, when the width β becomes smaller, the width in the X-axis direction of the electrically-conductive elastic bodies 12, 22 decreases, and thus, the resistance value of the electrically-conductive elastic bodies 12, 22 becomes large. Further, when the width β becomes small, the range in which the width in the vertical direction (the X-axis direction) is constant becomes small, and thus, it becomes difficult to position the conductor wire 13 in this range. Further, as described above, reduction in the width β is limited due to the printing method.

Thus, when the width β is reduced, there is a trade-off relationship between: improvement of the linearity of the relationship between the load and the contact area; and decrease in the detection sensitivity of the load, increase in the resistance value of the electrically-conductive elastic bodies 12, 22, and the like. Therefore, it is preferable that the width β is set in consideration of such a trade-off relationship.

In the simulation result shown in FIG. 11, when the width β was 0.5×w1, the coefficient of determination R² was 0.95, and linearity between the load and the contact: area was able to be relatively favorably ensured. Therefore, the width β may be set in a range of not less than 1 μm and not larger than 0.5 times the width w1 of the electrically-conductive elastic bodies 12, 22 in consideration of the above trade-off relationship.

Next, the inventors verified a preferable change ratio of the area of the electrically-conductive elastic body 12, 22 due to the cutout 12a, 22a, when the constant α was changed with the value of the width β fixed to 0.

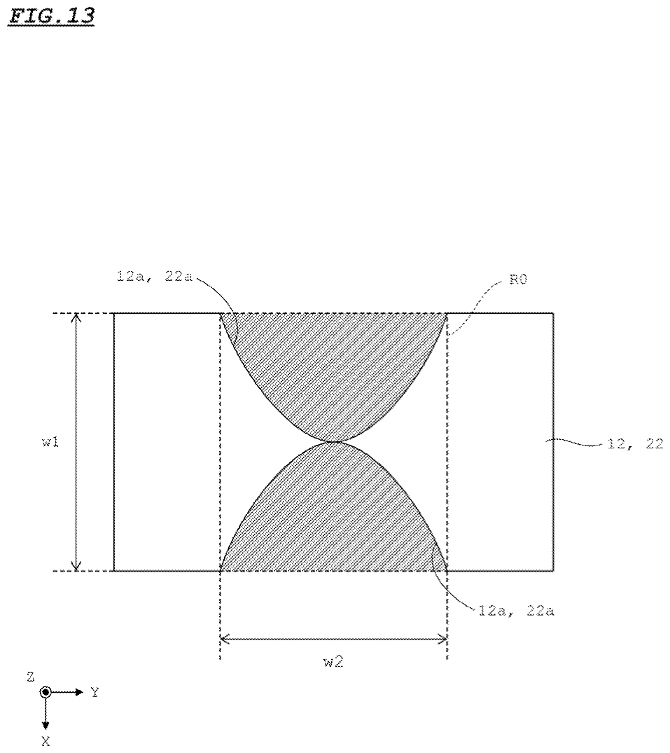

Here, as shown in FIG. 13, the change ratio was defined as the ratio of the total area of the cutout 12a, 22a included in a rectangular region R0 defined in the electrically-conductive elastic body 12, 22 by the width w1 and the width w2, relative to the total area of the region R0.

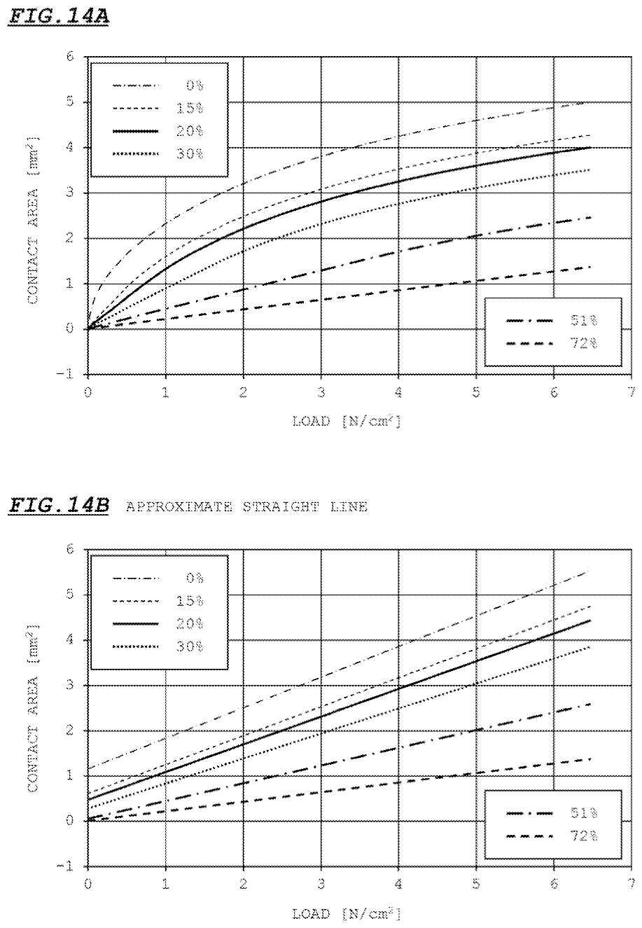

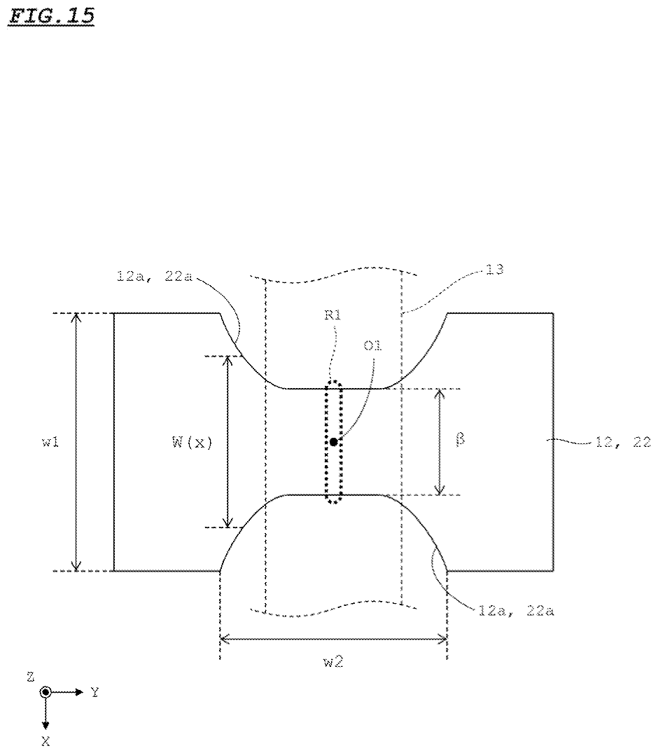

FIG. 14A is a graph showing the relationship between the load and the contact area when the above change ratio was changed in association with change in the constant α. FIG. 14B is a graph showing an approximate straight line of each curve in FIG. 14A.

In the graphs in FIGS. 14A, 14B, the horizontal axis represents the load (N/cm²) and the vertical axis represents the contact area (mm²).

A change ratio of 0% indicates a case where the width of the electrically-conductive elastic bodies 12, 22 was w1 and constant, that is, a case where the cutouts 12a, 22a were not provided as in Comparative Example shown in FIG. 5B. The coefficient of determination R² corresponding to the change ratios of 0%, 15%, 20%, 30%, 51%, 72% were 0.9145, 0.9383, 0.95, 0.97, 0.9962, 0.9999, respectively.

As shown in FIGS. 14A, 14B, the relationship between the load and the contact area becomes close to a straight line when the change ratio becomes larger, and the coefficient of determination R² based on the approximate curve becomes close to 1. However, as described with reference to FIGS. 9A to 9D, when the area of the cutout 12a, 22a becomes large, and the change ratio becomes large, decrease in the detection sensitivity of the load and increase in the resistance value of the electrically-conductive elastic bodies 12, 22 are caused. Therefore, it is preferable that the change ratio is set in consideration of such a trade-off relationship.

According to the simulation result shown in FIGS. 14A, 14B, when the change ratio was 20%, the coefficient of determination R² was 0.95, and linearity between the load and the contact area was able to be relatively favorably ensured. Therefore, the change ratio may be set in a range of not less than 20% in consideration of the above trade-off relationship.

Next, effects of the cutouts 12a, 22a having a symmetrical shape will be described.

FIG. 15 shows an example of a configuration of the cutouts 12a, 22a in the present embodiment, similar to FIG. 10.

In FIG. 15, an initial contact region R1 is a region where the conductor wire 13 and the electrically-conductive elastic bodies 12, 22 are in contact with each other in a no-load state. In other words, the initial contact region R1 is a linear shaped region passing through the center position in the Y-axis direction of the conductor wire 13 and extending in the X-axis direction. A center O1 is the center of the initial contact region R1. In other words, the center O1 is the center of the crossing position between the conductor wire 13 and the electrically-conductive elastic bodies 12, 22.

In the present embodiment, on both sides of the initial contact region R1, the cutouts 12a, 22a are formed such that the width in the X-axis direction of the electrically-conductive elastic bodies 12, 22 changes. Accordingly, the contact area can be efficiently changed in association with the load, and thus, the relationship between the load and the contact area is easily made close to a linear relationship.

In the present embodiment, the cutouts 12a, 22a are provided so as to be symmetrical in the Y-axis direction with respect to the initial contact region R1. Accordingly, in FIG. 15, even when the center of gravity of the load is displaced from the center O1 to the Y-axis positive direction or the Y-axis negative direction, the contact area between the conductor wire 13 and the electrically-conductive elastic bodies 12, 22 is substantially the same. Therefore, variation in the detected load when an unbalanced load has occurred in the Y-axis direction can be suppressed. In addition, the cutouts 12a, 22a are provided so as to be symmetrical in the X-axis direction with respect to the initial contact region R1. Thus, similarly, even when an unbalanced load has occurred in the X-axis direction, the contact area between the conductor wire 13 and the electrically-conductive elastic bodies 12, 22 is substantially the same. Therefore, variation in the detected load when an unbalanced load has occurred in the X-axis direction can be suppressed.

Thus, in the present embodiment, the cutouts 12a, 22a are provided so as to be symmetrical in the Y-axis direction and symmetrical in the X-axis direction with respect to the initial contact region R1. Therefore, even when an unbalanced load has occurred in the Y-axis direction and the X-axis direction with respect to the center O1, variation in the detected load can be suppressed. In the present embodiment, since the cutouts 12a, 22a have a shape symmetrical with respect to the center O1, variation in detection of the load due to an unbalanced load in a direction parallel to an X-Y plane can be suppressed from occurring.

### Effects of Embodiment

According to the embodiment, the following effects are exhibited.

The width of the electrically-conductive elastic bodies 12, 22 in the longitudinal direction of the electrically-conductive member 13a is changed such that the relationship between the load and the contact area between the electrically-conductive elastic bodies 12, 22 and the electrically-conductive member 13a via the dielectric body 13b becomes close to a linear relationship. With this configuration, as described with reference to FIG. 8, due to change in the width of the electrically-conductive elastic bodies 12, 22, the relationship between the load and the contact area between the electrically-conductive elastic bodies 12, 22 and the electrically-conductive member 13a is made close to a linear relationship. Thus, the relationship between the load and the capacitance is also made close to a linear relationship. Therefore, through detection of the capacitance between the electrically-conductive elastic bodies 12, 22 and the electrically-conductive member 13a, the applied load can be detected smoothly and in a simple manner.

In a case where the magnitude of the load when the length, in the circumferential direction of the electrically-conductive member 13a, of the contact portion between the electrically-conductive elastic bodies 12, 22 and the electrically-conductive member 13a via the dielectric body 13b is defined as x, is represented by function f(x), the width W(x) of the electrically-conductive elastic bodies 12, 22 in the contact portion is adjusted so as to be proportional to f′(x) which is a differential function of function f(x), as shown in formula (2) above. With this configuration, the relationship between the load and the contact area between the electrically-conductive elastic bodies 12, 22 and the electrically-conductive member 13a can be made closer to a linear relationship. Therefore, through detection of the capacitance between the electrically-conductive elastic bodies 12, 22 and the electrically-conductive member 13a, the applied load can be more accurately detected.

The contact area when the maximum load in the detection range has been applied is reduced by not less than 20%, as compared with a case where the width in the X-axis direction of the electrically-conductive elastic bodies 12, 22 is constant. As described with reference to FIGS. 14A, 14B, in order to make the relationship between the load and the contact area between the electrically-conductive elastic bodies 12, 22 and the electrically-conductive member 13a closer to a linear relationship, the width of the electrically-conductive elastic bodies 12, 22 needs to be changed such that the contact area when the maximum load in the detection range has been applied is reduced by not less than 20% as compared with a case where the width is constant. Thus, when the width of the electrically-conductive elastic bodies 12, 22 is changed such that the contact area when the maximum load in the detection range has been applied is reduced by not less than 20 as compared with a case where the width is constant, the relationship between the contact area and the load can be made closer to a linear relationship, and the applied load can be more accurately detected.

The width of the electrically-conductive elastic bodies 12, 22 is changed due to omission of a part of the electrically-conductive elastic bodies 12, 22 of which the width in the X-axis direction is constant. Specifically, the cutout 12a is provided in end portions in the width direction (the X-axis direction) of the electrically-conductive elastic body 12 of which the width is constant, and the cutout 22a is provided in end portions in the width direction (the X-axis direction) of the electrically-conductive elastic body 22 of which the width is constant, whereby the width of the electrically-conductive elastic bodies 12, 22 is changed. Accordingly, the width of the electrically-conductive elastic bodies 12, 22 in the longitudinal direction of the electrically-conductive member 13a can be easily changed to a desired state.

As shown in FIG. 15, a shape change for changing the width in the X-axis direction of the electrically-conductive elastic bodies 12, 22 is provided on both sides of the initial contact region R1, by means of the cutouts 12a, 22a. Accordingly, the contact area can be efficiently changed in association with the load, and the relationship between the load and the contact area is easily made close to a linear relationship. Therefore, the applied load can be more accurately detected.

As shown in FIG. 15, the shape change for changing the width in the X-axis direction of the electrically-conductive elastic bodies 12, 22 is provided so as to be symmetrical in a direction (the Y-axis direction) perpendicular to the longitudinal direction of the electrically-conductive member 13a with respect to the initial contact region R1. Accordingly, even when the center of gravity of the load is displaced from the center O1 to the Y-axis positive direction or the Y-axis negative direction, the contact area between the conductor wire 13 and the electrically-conductive elastic bodies 12, 22 is substantially the same. Therefore, variation in the detected load when an unbalanced load has occurred in the Y-axis direction can be suppressed.

As shown in FIG. 15, the shape change for changing the width in the X-axis direction of the electrically-conductive elastic bodies 12, 22 is provided so as to be symmetrical in the longitudinal direction (the X-axis direction) of the electrically-conductive member 13a with respect to the center O1 of the initial contact region R1. Accordingly, even when the center of gravity of the load is displaced from the center O1 to the X-axis positive direction or the X-axis negative direction, the contact area between the conductor wire 13 and the electrically-conductive elastic bodies 12, 22 is substantially the same. Therefore, variation in the detected load when an unbalanced load has occurred in the X-axis direction can be suppressed.

### <Modification of Shape of Electrically-Conductive Elastic Body>

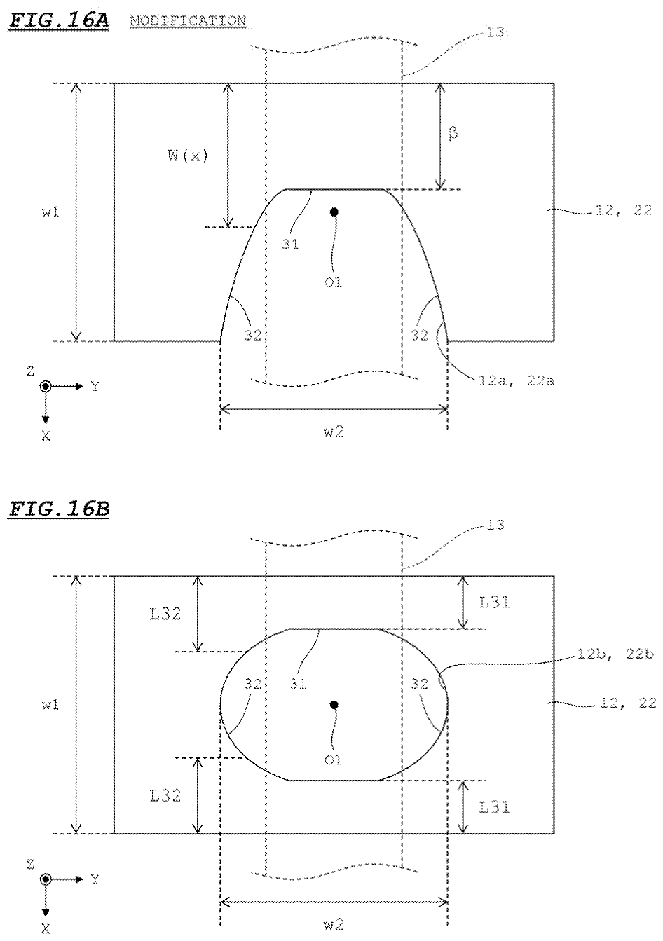

In the above embodiment, as shown in FIG. 15, as a shape for changing the width in the X-axis direction of the electrically-conductive elastic bodies 12, 22, the cutouts 12a, 22a are provided in end portions in the X-axis direction of the electrically-conductive elastic bodies 12, 22. However, the shape for changing the width in the X-axis direction of the electrically-conductive elastic bodies 12, 22 is not limited to the above, and may be a shape shown in FIG. 16A to FIG. 18B, for example. With the configuration as in FIG. 16A to FIG. 18B, the width of the electrically-conductive elastic bodies 12, 22 in the longitudinal direction of the electrically-conductive member 13a can be easily changed to a desired state.

In a modification shown in FIG. 16A, the cutouts 12a, 22a are provided only in an end portion on the X-axis positive side of the electrically-conductive elastic bodies 12, 22. In an end portion on the X-axis negative side of the cutouts 12a, 22a, the straight line part 31 extending in the Y-axis direction is formed, and on the Y-axis positive side and the Y-axis negative side of the straight line part 31, the curved line part 32 is formed. The width in the X-axis direction of the electrically-conductive elastic bodies 12, 22 corresponding to the straight line part 31 is the constant width β described above. The width in the X-axis direction of the electrically-conductive elastic bodies 12, 22 corresponding to the curved line parts 32 is adjusted so as to change according to function W(x) based on formula (2) above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship, and the relationship between the load and the capacitance can also be made close to a linear relationship.

In the modification in FIG. 16A, the shape of the electrically-conductive elastic bodies 12, 22 in the vicinity of the center O1 is symmetrical in the Y-axis direction. Therefore, even when the center of gravity of the load is displaced from the center O1 to the Y-axis positive direction or the Y-axis negative direction, the contact area between the conductor wire 13 and the electrically-conductive elastic bodies 12, 22 is substantially the same. Therefore, variation in the detected load when an unbalanced load has occurred in the Y-axis direction can be suppressed.

In the modification shown in FIG. 16B, in the vicinity of the center O1, an opening 12b penetrating the electrically-conductive elastic body 12 is provided in an inner portion in the width direction (the X-axis direction) of the electrically-conductive elastic body 12, and in the vicinity of the center O1, an opening 22b penetrating the electrically-conductive elastic body 22 is provided in an inner portion in the width direction (the X-axis direction) of the electrically-conductive elastic body 22. The openings 12b, 22b are at the same position and have the same shape in a plan view. In end portions on the X-axis positive side and the X-axis negative side of the openings 12b, 22b, the straight line part 31 extending in the Y-axis direction is formed, and on the Y-axis positive side and the Y-axis negative side of the straight line part 31, the curved line part 32 is formed. The width of the electrically-conductive elastic bodies 12, 22 corresponding to the straight line part 31 is a constant value L31. The value of L31×2 is the constant width β described above. The width of the electrically-conductive elastic bodies 12, 22 corresponding to the X-axis positive side and the X-axis negative side of the curved line part 32 is L32. The value of L32×2 is W(x) described above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship, and the relationship between the load and the capacitance can also be made close to a linear relationship.

In the modification in FIG. 16B, the shape of the electrically-conductive elastic bodies 12, 22 in the vicinity of the center O1 is symmetrical in the X-axis direction and symmetrical in the Y-axis direction with respect to the center O1. Therefore, even when an unbalanced load has occurred in the X-axis direction and the Y-axis direction with respect to the center O1, variation in the detected load can be suppressed. In addition, the shape of the electrically-conductive elastic bodies 12, 22 in the vicinity of the center O1 is symmetrical with respect to the center O1. Therefore, even when an unbalanced load has occurred in a direction parallel to an X-Y plane, variation in the detected load can be suppressed.

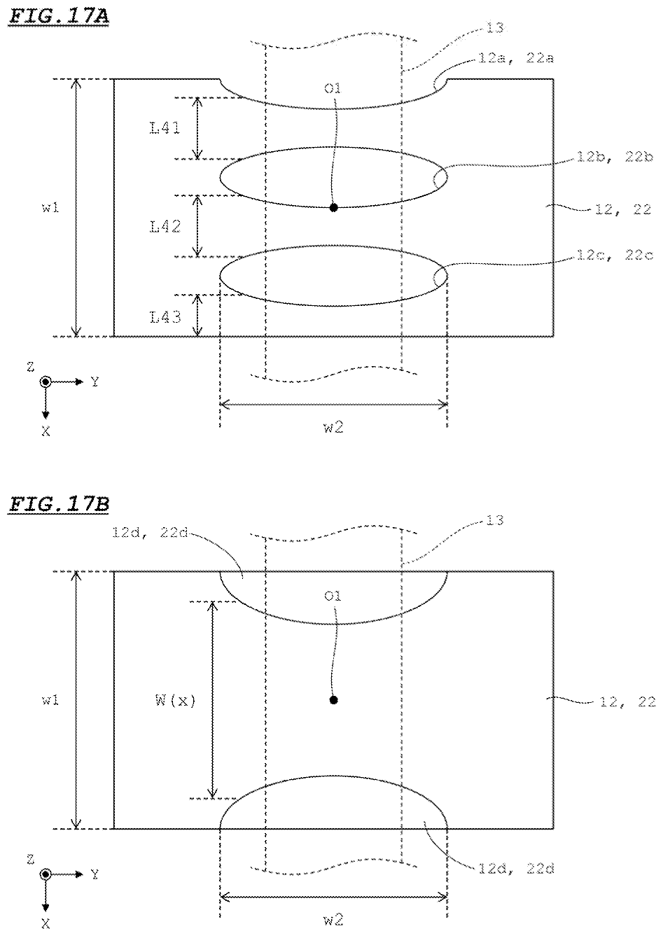

In the modification shown in FIG. 17A, the cutouts 12a, 22a are provided in an end portion on the X-axis negative side of the electrically-conductive elastic bodies 12, 22. In addition, the openings 12b, 22b and openings 12c, 22c are provided so as to be arranged in the X-axis direction. The cutout 12a and the openings 12b, 12c are provided in the electrically-conductive elastic body 12, and the cutout 22a and the openings 22b, 22c are provided in the electrically-conductive elastic body 22. The lengths in the Y-axis direction of the cutouts 12a, 22a and the openings 12b, 22b, 12c, 22c are each w2. In the range of the width w2, the width in the X-axis direction of the electrically-conductive elastic bodies 12, 22 is L41, L42, and L43. The value of L41+L42+L43 is W(x) described above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship, and the relationship between the load and the capacitance can also be made close to a linear relationship.

In the modification in FIG. 17A, the shape of the electrically-conductive elastic bodies 12, 22 in the vicinity of the center O1 is symmetrical in the Y-axis direction with respect to the center O1. Therefore, even when an unbalanced load has occurred in the Y-axis direction with respect to the center O1, variation in the detected load can be suppressed.

In the modification shown in FIG. 17B, openings 12d, 22d are provided in end portions on the X-axis positive side and the X-axis negative side of the electrically-conductive elastic bodies 12, 22. The opening 12d is a recess having a bottom face lower in the Z-axis negative direction than the face (the face in contact with the conductor wire 13) on the Z-axis positive side of the electrically-conductive elastic body 12. The opening 22d is a recess having a bottom face lower in the z-axis positive direction than the face (the face in contact with the conductor wire 13) on the Z-axis negative side of the electrically-conductive elastic body 22. The bottom faces of the openings 12d, 22d are not in contact with the conductor wire 13. The lengths in the Y-axis direction of the openings 12d, 22d are each w2. In the range of the width w2, the width in the X-axis direction of the electrically-conductive elastic bodies 12, 22 is W(x) described above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship, and the relationship between the load and the capacitance can also be made close to a linear relationship.

In the modification in FIG. 17B, the shape of the electrically-conductive elastic bodies 12, 22 in the vicinity of the center O1 is symmetrical in the X-axis direction and symmetrical in the Y-axis direction with respect to the center O1. Therefore, even when an unbalanced load has occurred in the X-axis direction and the Y-axis direction with respect to the center O1, variation in the detected load can be suppressed. In addition, the shape of the electrically-conductive elastic bodies 12, 22 in the vicinity of the center O1 is symmetrical with respect to the center O1. Therefore, even when an unbalanced load has occurred in a direction parallel to an X-Y plane, variation in the detected load can be suppressed.

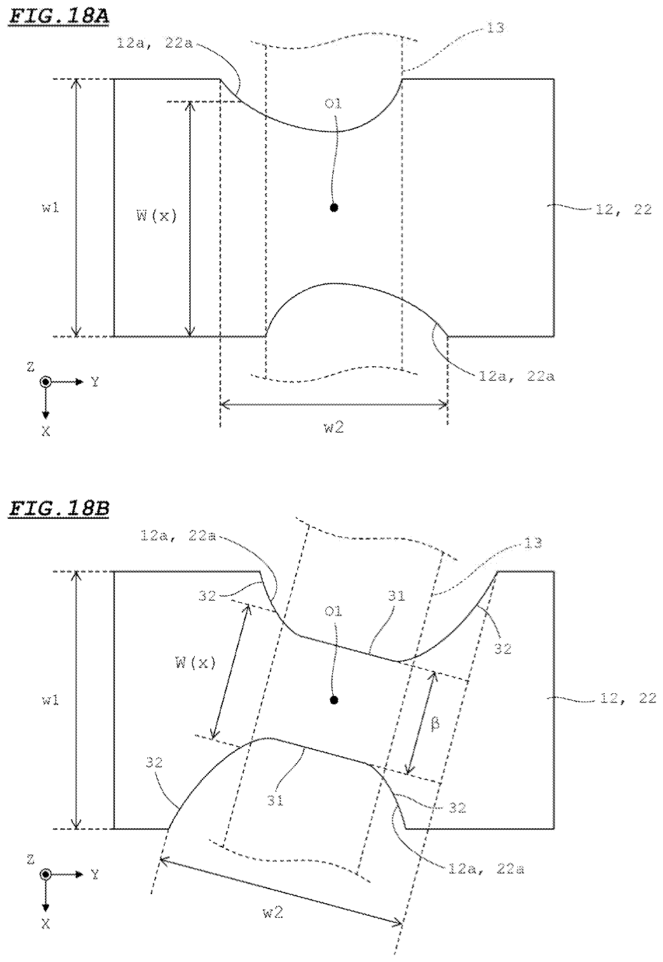

In the modification shown in FIG. 18A, the cutouts 12a, 22a are provided in end portions on the X-axis positive side and the X-axis negative side of the electrically-conductive elastic bodies 12, 22. The cutouts 12a, 22a on the X-axis positive side are at a position shifted to the Y-axis positive side in the range of the width w2, and the cutouts 12a, 22a on the X-axis negative side are at a position shifted to the Y-axis negative side in the range of the width w2. The cutout 12a and the cutout 22a have a shape in point symmetry with respect to the center O1. In the range of the width w2, the width in the X-axis direction of the electrically-conductive elastic bodies 12, 22 is W(x) described above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship, and the relationship between the load and the capacitance can also be made close to a linear relationship.

In the modification in FIG. 13A, the shape of the electrically-conductive elastic bodies 12, 22 in the vicinity of the center O1 is symmetrical with respect to the center O1. Therefore, even when an unbalanced load has occurred in a direction parallel to an X-Y plane, variation in the detected load can be suppressed.

In the modification shown in FIG. 18B, the conductor wire 13 is disposed at a position rotated about the center O1 in an X-Y plane, from the position where the conductor wire 13 perpendicularly crosses the electrically-conductive elastic bodies 12, 22. That is, in a plan view, the conductor wire 13 and the electrically-conductive elastic bodies 12, 22 cross each other at an angle other than 90°. In accordance with this, the cutouts 12a, 22a of the electrically-conductive elastic bodies 12, 22 are also formed at a position similarly rotated in an X-Y plane. In the longitudinal direction of the conductor wire 13, the interval between the two straight line parts 31 facing each other is the constant width β described above, and the interval between the two curved line parts 32 facing each other in the longitudinal direction of the conductor wire 13 is W(x) described above.

In this case as well, similar to the above embodiment, through appropriate setting of the constant α and the width β, the relationship between the load and the contact area between the electrically-conductive elastic bodies 12, 22 and the electrically-conductive member 13a can be made close to a linear relationship and the relationship between the load and the capacitance can also be made close to a linear relationship.

In the modification in FIG. 18B, the shape of the electrically-conductive elastic bodies 12, 22 in the vicinity of the center O1 is symmetrical with respect to the center O1. Therefore, even when an unbalanced load has occurred in a direction parallel to an X-Y plane, variation in the detected load can be suppressed.

### Other Modification

The configuration of the load sensor 1 can be modified in various ways other than the configurations shown in the above embodiment and the above modifications.

For example, in the above embodiment, the cutout 12a provided in the electrically-conductive elastic body 12 and the cutout 22a provided in the electrically-conductive elastic body 22 have the same shape and are provided so as to overlap each other in a plan view. However, not limited thereto, the cutout 12a and the cutout 22a may have the same shape and be disposed so as to be shifted from each other, or may have shapes different from each other, or only one of the cutouts 12a, 22a may be provided. In the above modifications as well, the cutout and opening of the electrically-conductive elastic body 12 and the cutout and opening of the electrically-conductive elastic body 22 may have the same shape and be disposed so as to be shifted from each other, or may have shapes different from each other, or only the cutout and opening of either one of the electrically-conductive elastic bodies 12, 22 may be provided.

Thus, also when the shapes and dispositions of the cutouts and openings are modified, similar to the above embodiment and modifications, the width of the electrically-conductive elastic bodies 12, 22 is set such that the relationship between the load and the contact area between the electrically-conductive member 13a and the electrically-conductive elastic bodies 12, 22 via the dielectric body 13b becomes close to a linear relationship. Accordingly, through detection of the capacitance between the electrically-conductive elastic bodies 12, 22 and the electrically-conductive member 13a, the applied load can be detected smoothly and in a simple manner.

In the above embodiment, one set of the cutouts (the cutouts 12a, 22a) are provided in the electrically-conductive elastic bodies 12, 22. However, not limited thereto, two sets or more of the cutouts may be provided so as to be arranged in the Y-axis direction.

In the modification shown in FIG. 16B, one set of penetrating openings (the openings 12b, 22b) are provided in the electrically-conductive elastic bodies 12, 22. However, not limited thereto, two sets or more of the penetrating openings may be provided. In this case, the two sets or more of the penetrating openings may be arranged in the X-axis direction, or may be arranged in the Y-axis direction.

In the modification shown in FIG. 17B, one set of the recess-shaped openings (the openings 12d, 22d) are provided in the electrically-conductive elastic bodies 12, 22, but the recess-shaped openings may be provided in an inner portion of the electrically-conductive elastic bodies 12, 22. In addition, two sets or more of the recess-shaped openings may be provided in the electrically-conductive elastic bodies 12, 22. In this case, the two sets or more of the recess-shaped openings may be arranged in the X-axis direction, or may be arranged in the Y-axis direction.

In the above embodiment and modifications, a configuration (cutout or opening) for changing the width in the X-axis direction of the electrically-conductive elastic bodies 12, 22 is provided on the Y-axis positive side and the Y-axis negative side of the initial contact region R1 (see FIG. 15). However, such a configuration may be provided on only one of the Y-axis positive side and the Y-axis negative side of the initial contact region R1. However, with this configuration, when loads have been applied to positions symmetrical in the Y-axis direction with respect to the initial contact region R1, variation may easily occur in the detected loads. Therefore, in order to suppress variation in the detected loads, it is preferable that a configuration (cutout or opening) for changing the width in the X-axis direction of the electrically-conductive elastic bodies 12, 22 is provided on both of the Y-axis positive side and the Y-axis negative side of the initial contact region R1, as in the above embodiment and modifications.

In the above embodiment, the pair of the conductor wires 13 are connected at an end portion on the X-axis positive side, but may be separated at the end portion on the X-axis positive side. That is, separate conductor wires 13 may be disposed so as to be arranged in the Y-axis direction. In this case, two conductor wires 13 passing through one sensor part A are connected to each other in a wiring or a circuit in a subsequent stage.

In the above embodiment, the load sensor 1 includes three pairs of the conductor wires 13, but may include one or more pairs of the conductor wires 13. For example, the number of the pairs of the conductor wires 13 included in the load sensor 1 may be one. Each sensor part A of the load sensor 1 includes two conductor wires 13 arranged in the Y-axis direction, but may include one or more conductor wires 13. For example, the number of the conductor wires 13 included in the sensor part A may be one. When the sensor part A of the load sensor 1 includes three or more conductor wires 13 arranged in the Y-axis direction, these conductor wires 13 may be connected to each other in an end portion of the X-axis direction, or may be connected to each other in a wiring or a circuit in a subsequent stage.

In the above embodiment, the load sensor 1 includes three sets of the electrically-conductive elastic bodies 12, 22 opposing each other in the up-down direction, but may include at least one set of the electrically-conductive elastic bodies 12, 22. For example, the number of the sets of the electrically-conductive elastic bodies 12, 22 included in the load sensor 1 may be one.

In the above embodiment, the cross-sectional shape of the electrically-conductive member 13a is a circle, but the cross-sectional shape of the electrically-conductive member 13a is not limited to a circle, and may be another shape such as an ellipse or a pseudo circle. The electrically-conductive member 13a may be implemented by a twisted wire obtained by twisting a plurality of electrically-conductive members. In these cases as well, similar to the above embodiment and modifications, the width of the electrically-conductive elastic bodies 12, 22 is set such that the relationship between the load and the contact area between the electrically-conductive member 13a and the electrically-conductive elastic bodies 12, 22 via the dielectric body 13b becomes close to a linear relationship.

In the above embodiment, the sensor part A includes one set of the electrically-conductive elastic bodies 12, 22 opposing each other in the up-down direction, but may include only one of the electrically-conductive elastic bodies 12, 22. That is, only one of the electrically-conductive elastic bodies 12, 22 may be disposed.

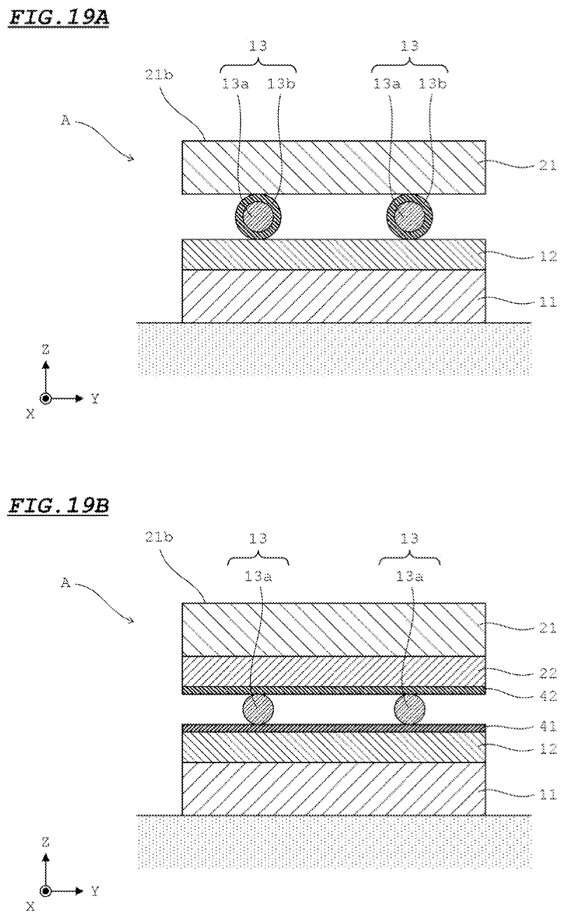

FIG. 19A schematically shows a configuration of a modification in which only the electrically-conductive elastic body 12 out of the electrically-conductive elastic bodies 12, 22 is disposed. In this case, when a load is applied to the upper face 21b of the sheet-shaped member 21 on the upper side, the conductor wire 13 is wrapped by the electrically-conductive elastic body 12, and the contact area between the electrically-conductive member 13a and the electrically-conductive elastic body 12 changes via the dielectric body 13b. In this case as well, similar to the above embodiment and modifications, the width of the electrically-conductive elastic body 12 is set such that the relationship between the load and the contact area between the electrically-conductive member 13a and the electrically-conductive elastic body 12 via the dielectric body 13b becomes close to a linear relationship. In this case, the variable x used in formulae (1), (2) above is the length of the arc of the contact portion between the conductor wire 13 and the electrically-conductive elastic body 12 when viewed in the X-axis direction.

In the above embodiment, the dielectric body 13b is disposed so as to cover the electrically-conductive member 13a, but instead of this, a dielectric body may be disposed on the opposing faces of the electrically-conductive elastic bodies 12, 22.

FIG. 19B schematically shows a configuration of a modification in which dielectric bodies 41, 42 are respectively disposed on the opposing faces of the electrically-conductive elastic bodies 12, 22. In this case, when a load is applied to the sensor part A, the electrically-conductive member 13a relatively moves toward the electrically-conductive elastic bodies 12, 22, and the contact area between the electrically-conductive member 13a and the dielectric bodies 41, 42 changes. Accordingly, the capacitance between the electrically-conductive elastic bodies 12, 22 and the electrically-conductive member 13a changes, and thus, the load in each sensor part A can be detected. In this case as well, similar to the above embodiment and modifications, the width of the electrically-conductive elastic bodies 12, 22 is set such that the relationship between the load and the contact area between the electrically-conductive member 13a and the electrically-conductive elastic bodies 12, 22 via the dielectric bodies 41, 42 becomes close to a linear relationship. In this case, the variable x used in formulae (1), (2) above is the entire length of the arc of the contact portion between the electrically-conductive member 13a and the dielectric bodies 41, 42 when viewed in the X-axis direction.

In addition to the above, various modifications can be made as appropriate to the embodiment of the present invention without departing from the scope of the technical idea defined by the claims.

What is claimed is:

1. A load sensor comprising:
an electrically-conductive elastic body;
an electrically-conductive member having a linear shape and disposed so as to cross the electrically-conductive elastic body; and
a dielectric body disposed between the electrically-conductive elastic body and the electrically-conductive member, wherein
a width of the electrically-conductive elastic body in a longitudinal direction of the electrically-conductive member is changed such that a relationship between a load and a contact area between the electrically-conductive elastic body and the electrically-conductive member via the dielectric body becomes close to a linear relationship.

2. The load sensor according to claim 1, wherein
in a case where a magnitude of a load when a length, in a circumferential direction of the electrically-conductive member, of a contact portion between the electrically-conductive elastic body and the electrically-conductive member via the dielectric body is defined as x, is represented by function f(x), the width of the electrically-conductive elastic body in the contact portion is adjusted so as to be proportional to f′(x) which is a differential function of function f(x).

3. The load sensor according to claim 1, wherein
the contact area when a maximum load in a detection range has been applied is reduced by not less than 20%, as compared with a case where the width is constant.

4. The load sensor according to claim 1, wherein
the width is changed due to omission of a part of the electrically-conductive elastic body of which the width is constant.

5. The load sensor according to claim 4, wherein
the width is changed due to provision of a cutout in an end portion in a width direction of the electrically-conductive elastic body of which the width is constant.

6. The load sensor according to claim 4, wherein
the width is changed due to provision of an opening in an inner portion in a width direction of the electrically-conductive elastic body of which the width is constant.

7. The load sensor according to claim 1, wherein
a shape change for changing the width is provided on both sides of an initial contact region where the electrically-conductive elastic body and the electrically-conductive member are in contact with each other via the dielectric body in a no-load state.

8. The load sensor according to claim 7, wherein
the shape change is provided so as to be symmetrical in a direction perpendicular to the longitudinal direction of the electrically-conductive member with respect to the initial contact region.

9. The load sensor according to claim 7, wherein
the shape change is provided so as to be symmetrical in the longitudinal direction of the electrically-conductive member with respect to a center of the initial contact region.

10. The load sensor according to claim 1, wherein
the dielectric body is formed on an outer periphery of the electrically-conductive member.

11. The load sensor according to claim 1, wherein
the electrically-conductive elastic body has a shape that is long in one direction, and
a plurality of the electrically-conductive members are disposed so as to be arranged in a longitudinal direction of the electrically-conductive elastic body.

12. The load sensor according to claim 1, wherein
a plurality of the electrically-conductive elastic bodies are disposed along the electrically-conductive member.
